(19) United States
(12) Patent Application Publication
(10) Pub. No.: US 2018/0180235 A1
(43) Pub. Date: Jun. 28, 2018

(54) SOLAR POWERED LIGHTING ASSEMBLY

(71) Applicant: Michaek St. Romain, Decatur, GA (US)

(72) Inventor: Michaek St. Romain, Decatur, GA (US)

(21) Appl. No.: 15/390,610

(22) Filed: Dec. 26, 2016

(51) Int. Cl. F21S 9/03; F21V 23/00; H02J 7/35; F21V 23/04

(52) U.S. Cl. CPC F21S 9/035; F21V 23/04; H02J 7/355; F21V 23/008

(57) ABSTRACT

A solar powered lighting apparatus comprising a base member, wherein the base member has a hollow interior compartment, a support system, wherein the support system is attached to the base member, a light receptacle, wherein the light receptacle is attached to the support system, a plurality of solar cells supported by the support system, and a power converter electronically connected to the plurality of solar cells, wherein the power converted by the power converter is sent to the light receptacle to provide power to a light source.

### BACKGROUND OF THE INVENTION

The present invention relates to lamp, and more particularly to lamp that integrates a solar panel and a battery for provide self-sufficient power.

Energy efficiency has become an area of interest for energy consuming devices. One class of energy consuming devices is lighting assemblies. Sustainable lighting solutions are essential to relief efforts in areas affected by natural disasters, war, and other events that leave large areas without electricity. One such sustainable light solutions is rechargeable batteries. However, these batteries tend to loss charge over time and are sometimes expensive to replace.

Solar power is a viable option to create sustainable lighting solution. Specifically, in situations certain situations require alternative lighting solutions, such as during limited or interrupted power access, or a lack of power altogether. Examples include cases of natural disaster and other emergencies, remote/rural locations far from a power station or electricity grid, and developing countries that have limited and/or unreliable power. Yet, current lighting options are often short-lived, unreliable, inefficient, non-reusable/non-rechargeable, impractical, and/or expensive to produce and operate.

Therefore, what is needed and heretofore lacking in prior lighting solutions is a lighting device that may be a self-sustaining light source, and potentially charge additional electronic devices

### SUMMARY

Aspects of an embodiment of the present invention disclose a solar powered lighting apparatus. The solar powered lighting apparatus comprises a base member, wherein the base member has a hollow interior compartment, a support system, wherein the support system is attached to the base member, a light receptacle, wherein the light receptacle is attached to the support system, a plurality of solar cells supported by the support system, and a power converter electronically connected to the plurality of solar cells, wherein the power converted by the power converter is sent to the light receptacle to provide power to a light source.

In preferred embodiments, the solar powered lighting apparatus further a battery electronically connected to the power converted, wherein the excess power that is not necessary to light the light source is stored in the battery. In preferred embodiments, the solar powered lighting apparatus a control module electronically connected to the power converter, wherein the control module relays information related to the energy absorbed by the plurality of solar cells. In preferred embodiments, the solar powered lighting apparatus's the power converter, the battery, and the control module are enclosed within the internal compartment of the base member.

In preferred embodiments, the solar powered lighting apparatus's locking mechanism to connect the plurality of solar cells to the support system. In preferred embodiments, the solar powered lighting apparatus's plurality of solar cells have a conical design. In preferred embodiments, the solar powered lighting apparatus a plug, wherein the plug is connected to the battery and can be used to recharge the battery or provide excess energy to an external power source. In preferred embodiments, the solar powered lighting apparatus's power switch electronically connected to the light receptacle, wherein the power switch controls the flow of power to the light receptacle. In preferred embodiments, the solar powered lighting apparatus's the power switch is an adjustable toggle switch.

### BRIEF DESCRIPTION OF THE DRAWINGS

FIG. 1 depicts an isometric view of a light source, in accordance with one embodiment of the present invention.

FIG. 2 depicts a section view of the light source, in accordance with one embodiment of the present invention.

FIG. 3 depicts a section view of an upper portion of the light source, in accordance with one embodiment of the present invention.

FIG. 4 depicts a section view of a lower portion of the light source, in accordance with one embodiment of the present invention.

### DETAILED DESCRIPTION OF THE INVENTION

The products of the present invention provide a light source with a solar panel to gather solar energy and convert the energy to power the light source as well as store excess energy for powering additional devices. This is helpful in emergency situations or being located in isolated areas where electricity is out or not accessible but the sun is visible.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein may also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

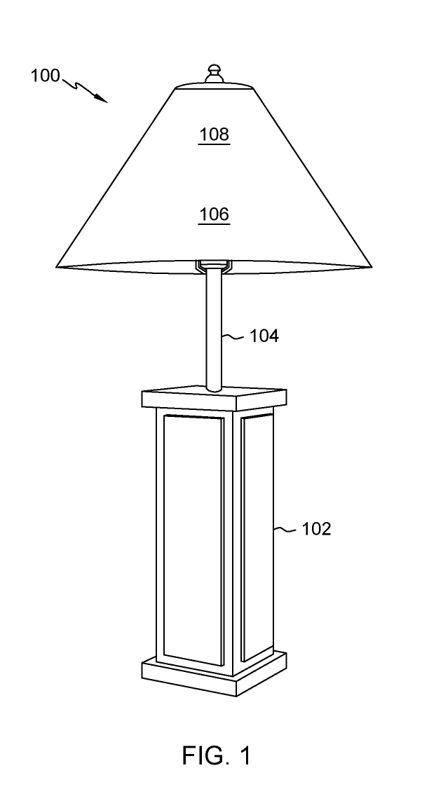

FIG. 1 depicts an isometric view of the light source 100, in accordance with one embodiment of the present invention. As depicted in FIG. 1, the light source 100 is comprised of a base 102 attached to a light receptacle assembly 104, which is connected to the solar cover 106, and solar panels (e.g. solar cells) 108 are attached to the solar cover 106.

Base 102 provides the structure for the light source 100 as well as provide an enclosure for all the additional components related to gathering, storing, and providing electricity that is gathered by the solar cover 106. The base 102 is depicted with a rectangular structure in FIG. 1, but may be various shapes, sizes, colors and designs. The material used for the base may be a plastic, wood, metal, or a combination of these materials that are known in the art. In some embodiments, the base 102 provides a waterproof design, so that the internal electrical components are protected in if used in wet environments. In the shown embodiment, the base 102 does not have a power cord, or power outlet. In additional embodiments, the base 102 can have a plug or power cord to connect to a power socket and use the power to charge a battery, or to return excess power back onto the grid.

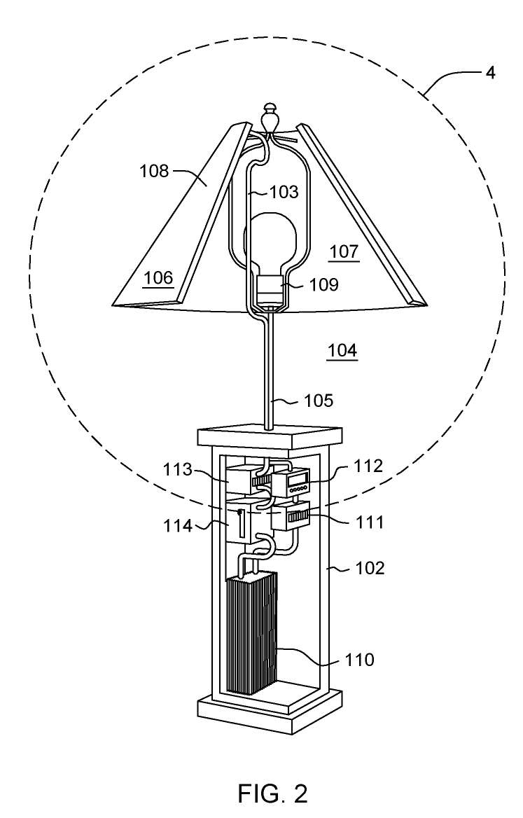

The light receptacle assembly 104 provides an enclosure for the necessary wiring to extend from the solar cover 106 to the internal components of the base 102, to provide a receptacle for a removable/replaceable light source (e.g. candescent light bulbs, light transmitting diode bulbs, or the like), and to create a support structure for the solar cover 106. In the depicted embodiment, the light receptacle assembly 104 is attached to the base 102 by an elongated tube, which extends upwards towards the light receptacle (shown in FIG. 2) which is attached to the support structure (shown in FIG. 2) that the solar cover 106 attaches to. The enclosure may be various lengths depending on the shape and size of the base 102, light receptacle, or the solar cover 106. The enclosure may be made from various materials or made into a variety of shapes.

The solar cover 106 provides an exposed surface for at least one solar panel 108 to be attached to. In the depicted embodiment, the solar cover 106 is a conical design. In additional embodiments, the solar cover 106 may have varying designs, sizes, angles, and number of solar panels 108. In one embodiment, the solar panels 108 are encapsulated in a clear solar cover 106 to provide a water-resistant design. The solar cover 106 is attached to the light receptacle 04 by various locking mechanisms. In the depicted embodiment, a screw lock is used to secure the solar cover 106 to the light receptacle 104. The solar panels 108 may be placed in various patterns, or in predetermined locations to maximize exposure to a light source.

Solar panels 108 are photovoltaic panels that absorb the sun's ray as a source of energy for generating electricity or heating. The solar panels 108 may be, but not limited to, crystalline silicon solar panels, monocrystalline solar panels, polycrystalline solar panels, or other forms of solar panels know to those skilled in the art. In some embodiments, solar panels 108 are malleable, and allow for the reshaping of the solar cover 106 to provide the ability to adjust the surface area that is exposed to the light source. The solar panels 108 are attached to the solar cover 106 by various means, such as, but not limited to, being a unitary component, adhesive, permanently affixing the solar panels 108 to the solar cover 106

FIG. 2 depicts a section view of the light source 100, in accordance with one embodiment of the present invention. FIG. 2 depicts the internal elements of the light source 100. In the depicted embodiment, the light source 100 is comprised of a base 102, a light receptacle 104, and a solar cover 106.

The base 102 is comprised of a battery 110, a capacitor 111, a control module 112, a power convert 113, and a power switch 114. The components contained within the base 102 are used to gather the energy absorbed by the solar panels 108, convert the energy, and store the energy. The power convert 113 is used to convert the energy between AC and DC voltages. The capacitor 111 is a passive two-terminal electrical component that is used to temporarily store the electrical energy converted by the power convert 113. The battery 110 is a rechargeable battery that stores the converted energy to be used to power the light, or external devices that are connected to the light source 100. The control module 112 and the power switch 114 are used to turn on the light, provide power to additional outlets, inform the user of energy gather from the solar panels 108, or the like. In one embodiment, the power switch 114 is an adjustable switch to dim the light. In one embodiment, the control module 112 records the amount of power absorbed. In various embodiments, the presence, location, and size of the battery 110, capacitor, 111 power module 112, power convert 113, and power switch 114 may be altered to maximize the amount of space consumed within the base 102 to provide the most efficient use of space within the base 102.

The light receptacle assembly 104 is comprised of an energy power supply wire 103, a light power supply wire 105, a light receptacle 109, and support structure 107. The energy power supply wire 103 is connected to the solar panels 108 either in series or in parallel to transfer the energy to the power convert 113. The light power supply wire 105 is connected to the battery 110 to provide power to the light. In some embodiments, these wires are enclosed in a casing or other apparatus to provide protection. The light receptacle 109 is a receptacle that is able to receive a light bulb. Support structure 107 is designed to support the weight and size of the solar cover assembly 106, so the lights source 100 is stable.

In the depicted embodiment, the solar panels 108 covers substantially the entire surface of the solar cover 106. In additional embodiments, the solar panels 108 cover a predetermined portion of the solar cover 106.

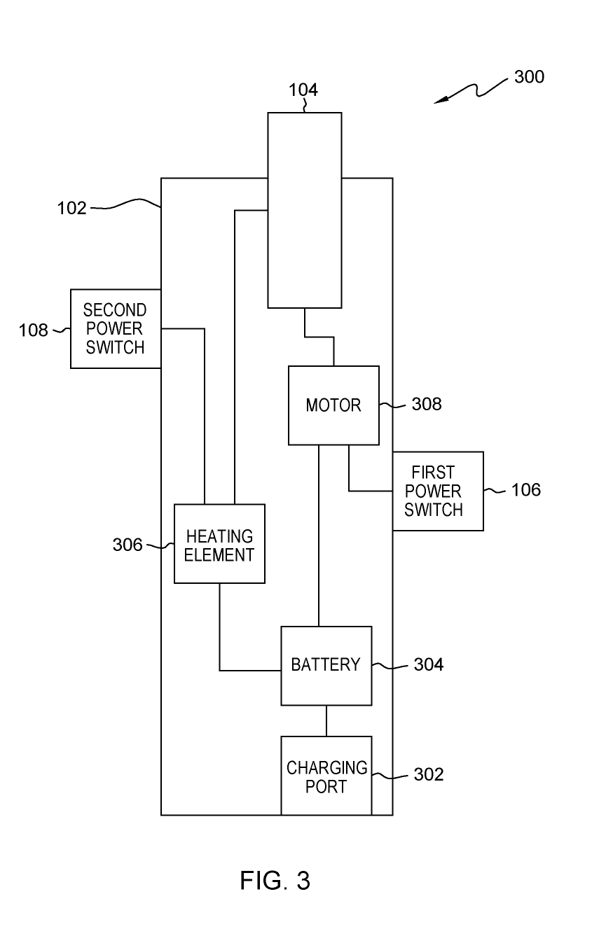

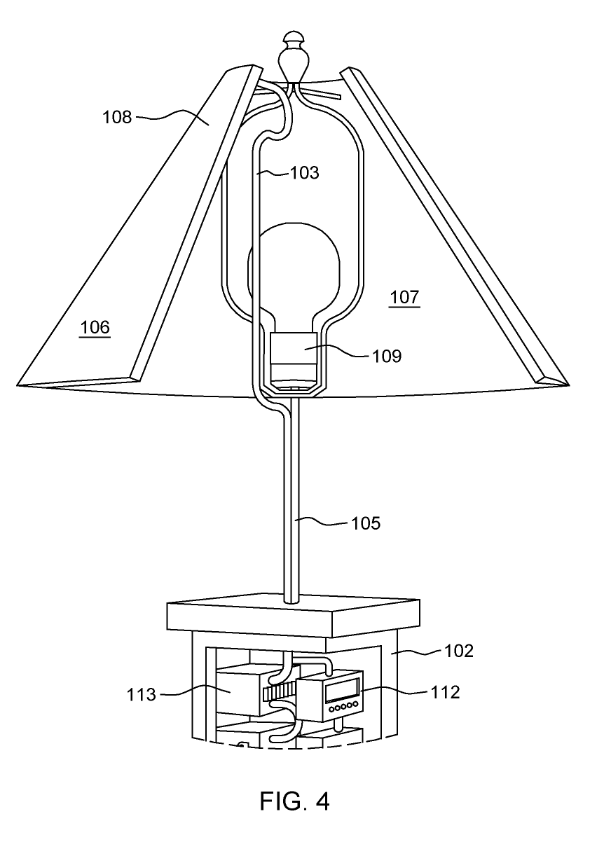

FIG. 3 depicts a section view of an upper portion of the light source, in accordance with one embodiment of the present invention. FIG. 4 depicts a section view of a lower portion of the light source, in accordance with one embodiment of the present invention.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A solar powered lighting apparatus, comprising:
a base member, wherein the base member has a hollow interior compartment;
a support system, wherein the support system is attached to the base member;
a light receptacle, wherein the light receptacle is attached to the support system;
a plurality of solar cells supported by the support system; and
a power converter electronically connected to the plurality of solar cells, wherein the power converted by the power converter is sent to the light receptacle to provide power to a light source.

2. The solar powered lighting apparatus of claim 1, further comprising:
a battery electronically connected to the power converted, wherein the excess power that is not necessary to light the light source is stored in the battery.

3. The solar powered lighting apparatus of claim 1, further comprising:
a control module electronically connected to the power converter, wherein the control module relays information related to the energy absorbed by the plurality of solar cells.

4. The solar powered lighting apparatus of claim 3, wherein the power converter, the battery, and the control module are enclosed within the internal compartment of the base member.

5. The solar powered lighting apparatus of claim 1, further comprising:
a locking mechanism to connect the plurality of solar cells to the support system.

6. The solar powered lighting apparatus of claim 1, wherein the plurality of solar cells have a conical design.

7. The solar powered lighting apparatus of claim 1, further comprising:
a plug, wherein the plug is connected to the battery and can be used to recharge the battery or provide excess energy to an external power source.

8. The solar powered lighting apparatus of claim 1, further comprising:
a power switch electronically connected to the light receptacle, wherein the power switch controls the flow of power to the light receptacle.

9. The solar powered lighting apparatus of claim 8, wherein the power switch is an adjustable toggle switch.

10. A solar powered lighting apparatus, comprising:
a hollow base member having a first end and a second end wherein the hollow base member is connected to a support system distal to the first end and the support system connects at least one solar cell to a power converted contained within the hollow base member and the power convert provides power to a light receptacle attached to the support system distal to the at least one solar cell.

11. The solar powered lighting apparatus of claim 10, further comprising:
a battery electronically connected to the power converted, wherein the excess power that is not necessary to light the light source is stored in the battery.

12. The solar powered lighting apparatus of claim 10, further comprising:
a control module electronically connected to the power converter, wherein the control module relays information related to the energy absorbed by the plurality of solar cells.

13. The solar powered lighting apparatus of claim 12, wherein the power converter, the battery, and the control module are enclosed within the internal compartment of the base member.

14. The solar powered lighting apparatus of claim 10, further comprising:
a locking mechanism to connect the plurality of solar cells to the support system.

15. The solar powered lighting apparatus of claim 10, wherein the plurality of solar cells have a conical design.

16. The solar powered lighting apparatus of claim 10, further comprising:
a plug, wherein the plug is connected to the battery and can be used to recharge the battery or provide excess energy to an external power source.

17. The solar powered lighting apparatus of claim 10, further comprising:
a power switch electronically connected to the light receptacle, wherein the power switch controls the flow of power to the light receptacle.

18. The solar powered lighting apparatus of claim 17, wherein the power switch is an adjustable toggle switch.
